(19) United States
(12) Patent Application Publication
(10) Pub. No.: US 2023/0400260 A1
(43) Pub. Date: Dec. 14, 2023

(54) FRACTAL STORE

(71) Applicant: Kraftblock GmbH, Sulzbach (DE)

(72) Inventor: Martin Schichtel, Sulzbach (DE)

(73) Assignee: Kraftblock GmbH, Sulzbach (DE)

(21) Appl. No.: 18/033,370

(22) PCT Filed: Oct. 1, 2021
(86) PCT No.: PCT/EP2021/077148

§ 371 Date: Apr. 24, 2023

(30) Foreign Application Priority Data
Oct. 23, 2020 (DE) 102020127987.6

(51) Int. Cl. F28D 20/00

(52) U.S. Cl. CPC F28D 20/0056; F28D 2020/0021; F28D 2020/0026; F28D 2020/0082

(57) ABSTRACT

Thermal store, wherein the thermal store includes a basic framework (14) of the thermal store, wherein the basic framework (14) has the form of a three-dimensional grid having a plurality of cells, wherein boundary surfaces between adjacent cells are surrounded by grid lines of the grid, wherein at least one, preferably a plurality, of the boundary surfaces between adjacent cells is permeable to a fluid in order to form a flow path from cell to cell for the fluid.

The invention relates to a thermal store and a method for providing a thermal store.

Thermal stores, or also thermal energy stores, heat stores, and/or cold stores of the type in question are used to store large amounts of heat. A thermal storage material is typically used, through which a fluid flows. The fluid can be a gas, for example. Heat can thus be transferred from the fluid to the storage material or heat can be transferred from the storage material to the fluid depending on the temperature of the fluid and the temperature of the thermal storage material. Such thermal stores are therefore capable, colloquially speaking, of storing heat and/or cold.

Such thermal stores have up to this point predominantly been designed, planned, and constructed “as a whole”. Individual conditions with respect to the design are typically to be taken into consideration here. This results in a comparatively lengthy and costly process until such a thermal store is made available.

A modular thermal store is known from WO 2017/046275 A1, which is assembled from a plurality of individual modules. Such a thermal store is scalable and can thus be adapted at least to a limited extent to individual requirements. In particular, the thermal store is scalable within limits. This is achieved in that fittings for the in-flow or outflow of the fluid are provided on the surface sides impermeable to the fluid. The individual modules can be connected to one another by means of these fittings.

However, such thermal stores also have disadvantages. The ability to combine the individual modules and thus the scalability is restricted by the positioning of the fittings on the modules to comparatively limited possible combinations of the spatial arrangement of the modules on one another. Furthermore, a through-flow, which takes place essentially “from fitting to fitting”, results within the modules. Areas (dead volumes) through which flow occurs comparatively poorly result in the individual modules. This reduces the capacity usable in practice and the efficiency of such thermal stores. The possibilities for “interconnecting” the modules when they are to be combined in a compact construction abutting one another are also limited, since the interconnection of the modules is comparatively strictly predeter-mined by the position of the fittings. The possibility of interconnecting such modules, for example, alternatively in parallel or in series is therefore limited. Furthermore, each module as such has to include partition walls which are impermeable to the fluid and thermally insulated in all directions. If the modules are arranged ad-joining to one another, which is advantageous with regard to the fewest possible surfaces facing toward the surroundings, via which heat losses can occur, and which involves the smallest space requirement, most of the insulated walls only separate areas of the thermal store from one another. Therefore, a comparatively large amount of insulation material is used at points where this would not be necessary, since these walls are ultimately not surfaces facing toward the environment and therefore relevant with regard to heat losses.

The invention is therefore based on the object of disclosing a modular thermal store and a method for providing a modular thermal store, in which the above-mentioned disadvantages do not occur or at least occur to a reduced extent and which in addition is to be adaptable and scalable as inexpensively and flexibly as possible to individual requirements.

The object is achieved by a thermal store and a method for providing a thermal store having the features of the independent claims. The features of the dependent claims relate to advantageous embodiments.

The illustrated and described thermal store includes a basic framework, wherein the basic framework has the form of a three-dimensional grid. The form of a three-dimensional grid is to be understood in this context in particular as the form of a grid in the meaning of geometry. A grid in geometry is a continuous and overlap-free partition of a space by a set of cells (which are also designated as grid cells, in the present application the term “cells” is used for language simplification). The cells of the grid are defined by a set of grid points, which are connected to one another by a set of grid lines. The grid lines surround boundary surfaces between adjacent cells in this case.

In other words, boundary surfaces between adjacent cells are defined by the basic framework, which are surrounded by the parts of the basic framework that corre-spond to the grid lines.

In the illustrated and described thermal store, at least one, preferably a plurality, of the boundary surfaces between adjacent cells is permeable to a fluid. The boundary surfaces permeable to the fluid between adjacent cells thus form a flow path from cell to cell.

The thermal store can include a plurality of structural elements, which form supports and/or girders in the basic framework of the thermal store, which are arranged in the area of the grid lines of the grid and are connected to one another in the area of the grid points of the grid.

The grid can be in particular a structured grid. A structured grid is understood as a grid which has a regular topology, i.e., the cells are present in a regular pattern and may be uniquely indexed by whole numbers.

Furthermore, the grid can be in particular a rectangular grid. This means that the individual cells of the grid have a cuboid shape.

Furthermore, the grid can be in particular a uniform grid, i.e., the edges of the cells of the grid oriented along an axis have equal length.

It is possible that the above-mentioned properties of the grid only apply to a section of the grid. However, they can apply in particular to the entire grid.

At least one, preferably a plurality, of the boundary surfaces between adjacent cells can be impermeable to the fluid. The flow path of the fluid through the store may thus be formed deliberately in particular, in that the individual boundary surfaces are each made either permeable to the fluid or impermeable to the fluid.

The illustrated and described thermal store can include a plurality of modules, which each form one cell of the grid. The modules can be arranged adjacent to one another and/or one over another and can be connected to one another in such a way that they form the basic framework of the thermal store and thus the cells of the grid.

The cells are each delimited by a plurality of boundary surfaces between adjacent cells. The cells abut one another with their boundary surfaces. The boundary surfaces do not necessarily have to be defined by components which separate the adjacent cells from one another. There can also be solely theoretical boundary surfaces, which are defined solely by a grid structure which is formed by the basic framework of the thermal store. In other words, the boundary surfaces can be open surfaces between the adjacent cells, which are formed, for example, by modules abutting one another with open surface sides.

Such a thermal store enables the thermal store to be planned in a simple manner by the combination of a plurality of standardized elements. The thermal store, in particular modules, structural elements as parts of the basic framework, such as supports and/or girders, floors, ceilings, outer walls, intermediate walls, and/or intermediate floors, can be formed in a simple manner as standardized elements, which can be prefinished in particular at a location remote from the location of the installation. In this way, on the one hand the planning and/or design effort of the thermal store under discussion is significantly reduced, which enables rapid provision. In addition, the costs are significantly reduced.

It is furthermore advantageous that a part of the boundary surfaces is permeable to the fluid, by which a simple possibility is provided for defining or specifying a flow path for the fluid in the thermal store. Other boundary surfaces can be designed to be impermeable to the fluid. This can be implemented, for example, by intermediate walls. The flow path for the fluid for an individual application case may thus be established by the embodiment of selected boundary surfaces as boundary surfaces permeable to the fluid or boundary surfaces impermeable to the fluid. By omit-ting intermediate walls which are oriented in parallel to the flow direction, cells can also be combined to form groups of cells, which thus form a flow path having a larger cross section than a single cell. The flow path can thus provide that the fluid flows through the individual cells of the thermal store in succession. Alternatively and/or additionally, it is possible for the fluid to flow in parallel through individual cells and/or groups of cells of the thermal store. In this way, the individual requirements which result from the respective application case on the thermal store can be taken into consideration.

The thermal store can in particular include a filling with a thermal storage material. The filling can be designed as a bulk material through which the fluid can flow and/or a lining through which the fluid can flow.

The thermal store can be in particular a so-called latent thermal store. Phase change materials are used as thermal storage materials in such thermal stores. The latent melting heat, solution heat, and/or absorption heat of such media is significantly greater than the heat which could be stored without utilization of such phase transformation effects.

Alternatively and/or additionally, it can be a so-called sensitive thermal store. Such thermal stores change their perceptible temperature upon charging and/or dis-charging. In particular, phase transitions do not occur in such thermal stores. Sensitive thermal stores are particularly well suitable for enabling broad and/or high temperature ranges. Such thermal stores are described, for example, in EP 3 187 563 A1.

Alternatively and/or additionally, the fluid itself can be used to store heat. This is advantageous in particular if the fluid itself has a high heat capacity and/or the store is operated so that the fluid has a long dwell time in the store.

The boundary surfaces permeable to the fluid can be open. Alternatively, achieving the permeability of the boundary surfaces in that the intermediate walls and/or intermediate floors arranged in the area of the boundary surfaces and/or used as boundary surfaces are designed in another way such that a passage of the fluid, which is in particular distributed over the boundary surface or at least over a signifi-cant part of the boundary surface, is possible through the boundary surface sug-gests itself. For example, one, a plurality, or a large number of openings can be provided in the intermediate wall and/or the intermediate floor. The intermediate wall and/or the intermediate floor can also be embodied as a grid and/or in the manner of a grid or can include a grid.

In particular in the case of open boundary surfaces, the filling can form an uninterrupted continuous bulk material and/or liner. In this way, the highest level of homo-geneity of the flow through the thermal store from cell to cell is achieved. At the same time, the interior of the thermal store can be utilized optimally for the filling with the thermal storage material.

The boundary surfaces can be rectangular. This is reasonable in particular in conjunction with cuboid cells. Such a geometry of the cells of the thermal store adapted to a rectangularly formed structure of the basic framework of the thermal store enables a simple type of construction and structural calculation.

In particular, boundary surfaces of adjacent cells abutting one another can have identical dimensions. In this way, the full area of the boundary surfaces can be used for the passage of the fluid through the boundary surface. It is particularly advantageous if the cells of the thermal store, in particular all cells of the thermal store, have identical dimensions. In this way, the highest level of ability to standard-ize prefinished elements and flexibility with respect to the implementation of different arrangements and/or flow paths in the thermal store is enabled.

The individual cells of the thermal store or the grid can have structural elements in the area of their edges, which form supports and/or girders in the basic framework of the thermal store. In this case, a structural element, in particular a support and/or a girder, can be associated with a plurality of cells of the grid or can be part of a plurality of cells of the basic framework. Such a thermal store can be formed, for example, in that the basic framework is assembled from the structural elements and the floors, ceilings, walls, intermediate walls, and/or intermediate floors are fas-tened to the basic framework formed from these structural elements.

Alternatively and/or additionally, it is possible that modules, in particular prefinished modules, each define a cell of the grid taken by themselves. These modules can have structural elements in the area of their edges, which each belong to a specific module. The individual modules can then be connected to one another using their structural elements, by which the basic framework is formed, wherein structural elements of adjacent modules jointly define grid lines of the grid.

The method for providing a thermal store, in particular a thermal store of the above-described type, provides in particular that initially a plurality of modules and/or structural elements of the basic framework, in particular supports and/or girders, are prefinished. The prefinished modules and/or structural elements are then transported to the installation location of the thermal store and there are arranged adjacent to one another and/or one over another and connected to one another. The basic framework of the thermal store results in this way.

It is possible to connect floors, ceilings, outer walls, intermediate walls, and/or intermediate floors of the thermal store to the modules already during the prefinishing of the modules. Alternatively and/or additionally, it is possible that initially only the basic framework is formed by means of prefinished modules, and floors, ceilings, outer walls, intermediate walls, and/or intermediate floors are first connected at the installation location to the basic framework of the thermal store.

It is possible that the thermal store is first filled with the thermal storage medium when it is provided at its installation location. This can be advantageous due to the weight of the thermal storage medium, which is often not insignificant, since the weight of the modules possibly to be transported is thus significantly reduced. The static carrying capacity of the thermal store also only has to be sufficient to carry the thermal storage medium in the installed state. It is then not necessary for the modules also to be able to be moved in the filled state, i.e., with the overall load exerted by the thermal storage material.

The thermal store can additionally include a thermal insulation. This can be applied at the location of the installation of the thermal store. Alternatively and/or additionally, it is possible to apply the thermal insulation of the thermal store, at least par-tially, thereto already during the prefinishing of the individual modules, structural elements, floors, ceilings, outer walls, intermediate walls, and/or intermediate floors.

The method can provide in particular that modules, structural elements, floors, ceilings, outer walls, intermediate walls, and/or intermediate floors compatible with one another are prefinished in dimensions already defined before the planning of the specific thermal store to be provided and in particular are already stocked before the planning of the specific thermal store to be provided, wherein to provide the thermal store, modules, structural elements, floors, ceilings, outer walls, intermediate walls, and/or intermediate floors are selected from the modules, structural elements, floors, ceilings, outer walls, intermediate walls, and/or intermediate floors which are prefinished and in particular already stocked before the planning of the specific thermal store to be provided and are used to construct the thermal store. In this way, it is possible to assemble the thermal store completely or at least in part from “standard components”. The costs and the provision times may thus be reduced still further. Moreover, the planning or design is already simplified by the use of standardized components. In other words, a type of “modular construction sys-tem” is provided, from which the thermal store may be assembled. If the components of the store are stocked, parts may even be used which are already available stored, due to which the provision time may be reduced still further.

Further practical embodiments and advantages of the invention are described hereinafter in conjunction with the drawings. In the figures:

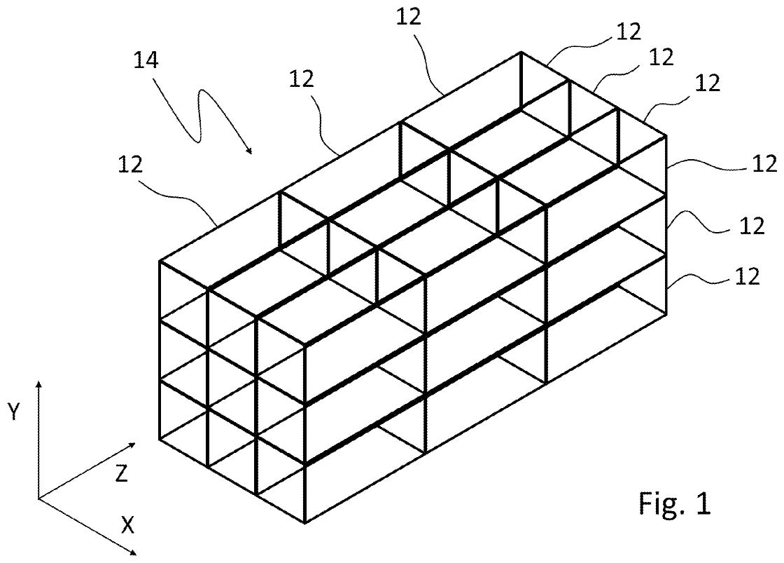

FIG. 1 shows a basic framework of a thermal store of the type under discussion in the form of a three-dimensional grid

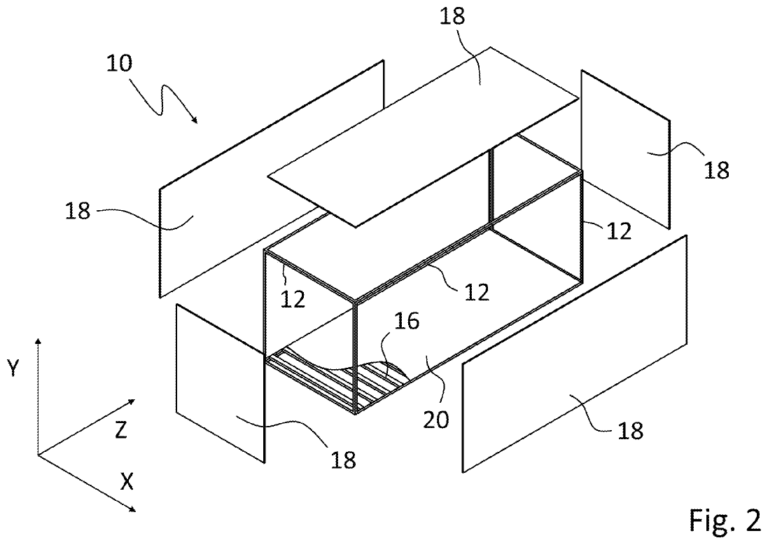

FIG. 2 shows an exemplary module and further exemplary parts of an exemplary thermal store

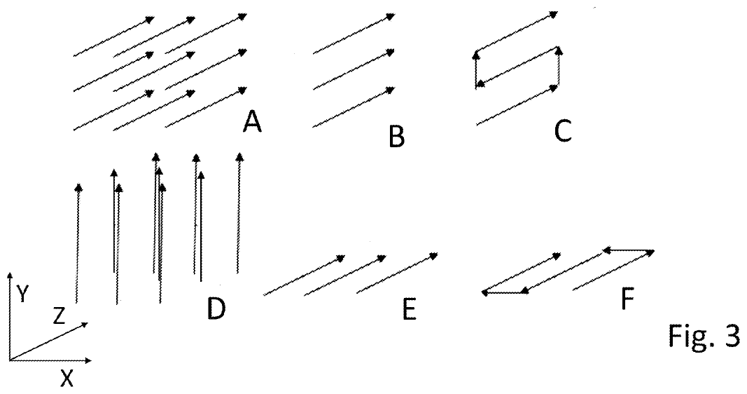

FIG. 3 shows a schematic illustration of exemplary variants of different flow paths which are implementable in thermal stores having identical basic frameworks.

The thermal store schematically shown in FIG. 1 includes a basic framework 14. The basic framework 14 has the form of a three-dimensional grid. The grid lines surround boundary surfaces between adjacent cells here. The basic framework is formed by structural elements 12, which define the grid lines of the grid as supports and/or girders in the basic framework 14.

The structural elements 12 of the basic framework and/or the modules 10 can be supplemented by intermediate walls, floors, intermediate floors, walls, and ceilings of the thermal store. These can be arranged on the boundary surfaces between the cells of the grid structure of the thermal store. The boundary surfaces between the cells can, as in the example shown, be defined by the open surface sides, framed by the structural elements 12, of the cells, which surface sides form the six sides of the cuboids, the basic shape of the exemplary cells of the grid. The cuboid cells thus formed form an expandable cell structure of the thermal store in this way.

The partition walls 18 and ceilings 20 shown by way of example in FIG. 2 can be used to implement intermediate floors, intermediate walls, outer walls, ceilings, and floors of the thermal store. Where corresponding partition walls 18 are provided as intermediate walls or corresponding ceilings 20 are provided as intermediate floors in the area of the boundary surfaces between adjacent cells, since they are not permeable to the fluid, these form boundaries of the flow path of the fluid through the thermal store. In this way, the through flow path through the thermal store may be defined by the positioning or by the addition or omission of the partition walls 18 at individual boundary surfaces.

The exemplary thermal store can include a plurality of exemplary modules 10, which each define individual cells of the grid or are constructed therefrom. An exemplary module 10 is depicted in FIG. 2. The exemplary module 10 includes structural elements 12, which are arranged along the edges of the module 10. The structural elements 12 of the module 10 can form a basic framework 14 of the thermal store in the form of a three-dimensional grid, as can be seen in FIG. 1, for example. Such a basic framework 14 of the thermal store can be formed in particular from a plurality of modules 10.

As in the example shown, the store can include additional girder elements 16 in the area of the ceilings, floors, and/or intermediate floors. For the purposes of the exemplary illustration of these girder elements, a part of the ceiling 20 used as a floor or intermediate floor is cut away in the illustration. Loads, for example exerted by a heat transfer medium which forms a filler of the thermal store, can be absorbed by the girder elements 16. However, the lower sides of the modules 10, which are only reinforced by the girder elements 16, preferably initially remain permeable to a fluid which flows through the thermal store, as long as, for example as shown, a ceiling 20 is not arranged to form a floor and/or intermediate floor in the area of the lower side of the module.

Different flow paths are shown by way of example in FIG. 3, which may be implemented by means of the basic framework 14 schematically shown in FIG. 1, which may be implemented, for example, with a total of 18 of the modules 10. In the case shown in FIG. 3A, there is flow through adjacent cells in the direction Z in each case. No partition walls 18 are provided at the boundary surfaces orthogonal to the direction Z between these cells. In this way, these boundary surfaces are permeable to the fluid. All other boundary surfaces between cells include partition walls 18 or ceilings 20. In this way, nine “channels” result, which are oriented in the Z direction and are independent from one another, through which flow can take place through the thermal store formed from its surface sides oriented in the direction Z. For this purpose, corresponding distributor devices for the fluid or collecting devices for the fluid can be provided at the entry or exit surfaces for the fluid facing in or counter to the direction Z.

In the case of the through-flow pattern shown in FIG. 3B, the boundary surfaces orthogonal to the direction X between cells are also permeable to the fluid. In comparison to FIG. 3A, only three “channels”, which are separate from one another and can each have flow through them, are thus formed, which each extend over one complete level of the thermal store shown by way of example.

In FIG. 3C, a flow path is shown by way of example, in which the fluid can flow through a part of the boundary surfaces orthogonal to the direction Z between adjacent cells. In this case, it is thus made possible for the flow to be guided in an S-shape initially through the lowermost level, then in the opposite direction through the middle level, and finally in the same flow direction as in the lowermost level through the uppermost level of the cell structure, schematically shown in FIG. 1, of the thermal store.

In FIG. 3D, the cells of the thermal store form by way of example nine individual channels which can have flow through them in the direction Z, thus vertically. In this case, all boundary surfaces orthogonal to the direction X or Y between adjacent cells of the grid are impermeable to the fluid. Only the boundary surfaces orthogonal to the direction Z between adjacent cells are permeable to the fluid.

In the schematic through-flow shown in FIG. 3E, in comparison to the flow pattern in FIG. 3D, the boundary surfaces orthogonal to the horizontal direction Y between adjacent cells of the grid are additionally permeable to the fluid. Such a cell structure can have flow through it in three channels through which flow can take place independently of one another, which have the form of vertically oriented “disks”, for example in the manner shown in FIG. 3B, namely in the direction Y.

A further example of an S-shaped flow through the basic framework 14 shown by way of example in FIG. 1 is shown in FIG. 3F. This may be implemented if in the case of the grid shown in FIG. 1, a part of the boundary surfaces orthogonal to the direction X between adjacent cells of the grid is permeable to the fluid. The other part of the boundary surfaces orthogonal to the direction X can then be made impermeable to the fluid by means of partition walls 18, for example, so that the S-shaped course of the flow is preset or forced.

The features of the invention disclosed in the present description, in the drawings, and in the claims can be essential both individually and also in any combinations for the implementation of the invention in its various embodiments. The invention is not restricted to the described embodiments. It can be varied in the scope of the claims and in consideration of the knowledge of the relevant person skilled in the art.

### LIST OF REFERENCE SIGNS

10 module
12 structural elements
14 basic framework
16 girder element
18 partition walls
20 ceilings
22 cell structure
X horizontal direction
Y vertical direction
Z horizontal direction

1. A thermal store, wherein the thermal store includes a basic framework (14) of the thermal store, wherein the basic framework (14) has the form of a three-dimensional grid having a plurality of cells, wherein boundary surfaces between adjacent cells are surrounded by grid lines of the grid, wherein at least one, preferably a plurality, of the boundary surfaces between adjacent cells is permeable to a fluid in order to form a flow path from cell to cell for the fluid.

2. The thermal store as claimed in claim 1, characterized in that at least one, preferably a plurality, of the boundary surfaces between adjacent cells is impermeable to the fluid.

3. The thermal store as claimed in claim 1 or 2, characterized in that the thermal store includes structural elements (12), which form supports and/or girders in the basic framework (14) of the thermal store, which are arranged in the area of the grid lines of the grid and are connected to one another in the area of the grid points of the grid.

4. The thermal store as claimed in any one of the preceding claims, characterized in that the thermal store includes a plurality of modules (10), wherein the modules (10) each form a cell of the grid, wherein the modules (10) are arranged adjacent to one another and/or one over another and are connected to one another in such a way that they form the basic framework and/or parts of the basic framework (14) of the thermal store.

5. The thermal store as claimed in any one of the preceding claims, characterized in that the thermal store includes a filling with a thermal storage material, which is designed as a bulk material and/or lining through which the fluid can flow.

6. The thermal store as claimed in any one of the preceding claims, characterized in that the boundary surfaces permeable to the fluid and abutting one another are open, in particular wherein the filling forms a continuous bulk material and/or lining uninterrupted by the open boundary surfaces.

7. The thermal store as claimed in any one of the preceding claims, characterized in that a part of the abutting boundary surfaces is not permeable to the fluid in order to preset a flow path through the thermal store for the fluid.

8. The thermal store as claimed in claim 7, characterized in that the boundary surfaces not permeable to the fluid include intermediate walls and/or intermediate floors.

9. The thermal store as claimed in any one of the preceding claims, characterized in that the boundary surfaces are rectangular, in particular wherein the cells are cuboid.

10. The thermal store as claimed in any one of the preceding claims, characterized in that the cells have identical dimensions.

11. The thermal store as claimed in any one of the preceding claims, characterized in that the individual modules (10) include structural elements (12) in the area of their edges, which structural elements form supports and/or girders in the basic framework (14) of the thermal store and are arranged in the area of the grid lines of the grid.

12. A method for providing a thermal store, in particular a thermal store as claimed in any one of the preceding claims, wherein initially a plurality of modules (10) and/or structural elements (12) of the basic framework (14), in particular supports and/or girders, are prefinished and then transported to the installation location of the thermal store and arranged adjacent to one another and/or one over another and connected to one another there, so that they form a basic framework (14) of the thermal store.

13. The method as claimed in claim 12, characterized in that the thermal store is filled with a thermal storage medium after connecting the modules (10).

14. The method as claimed in one of claim 12 or 13, characterized in that modules (10), structural elements (12), floors, ceilings (20), outer walls, intermediate walls, and/or intermediate floors compatible with one another are prefinished in dimensions already defined before the planning of the specific thermal store to be provided and in particular are stocked already before the planning of the specific thermal store to be provided, wherein to provide the thermal store, modules (10), structural elements (12), floors, ceilings, outer walls, intermediate walls, and/or intermediate floors are selected from the modules (10), structural elements (12), floors, ceilings, outer walls, intermediate walls, and/or intermediate floors which are prefinished and in particular already stocked before the planning of the specific thermal store to be provided and are used to construct the thermal store.
